(19) United States
(12) Patent Application Publication
(10) Pub. No.: US 2008/0270567 A1
(43) Pub. Date: Oct. 30, 2008

(54) Customizing and Distributing Data in Network Environments

(75) Inventors: Todd Stiers, Berkeley, CA (US); Jeremy de Bonet, Windham, NH (US)

Correspondence Address: BEYER WEAVER LLP, P.O. BOX 70250, OAKLAND, CA, 94612-0250, US

(73) Assignee: MOBITV, INC., Emeryville, CA (US)

(21) Appl. No.: 11/694,716

(22) Filed: Mar. 30, 2007

Related U.S. Application Data
(60) Provisional application No. 60/788,181, filed on Mar. 31, 2006.
(60) Provisional application No. 60/788,180, filed on Mar. 31, 2006.
(60) Provisional application No. 60/788,179, filed on Mar. 31, 2006.
(60) Provisional application No. 60/790,268, filed on Apr. 7, 2006.
(60) Provisional application No. 60/790,334, filed on Apr. 7, 2006.
(60) Provisional application No. 60/791,326, filed on Apr. 12, 2006.
(60) Provisional application No. 60/790,260, filed on Apr. 7, 2006.

(51) Int. Cl. G06F 15/16

(52) U.S. Cl. 709/217

(57) ABSTRACT

Various techniques and mechanisms allow customization of data for delivery to different end users. The data can be provided as a series of chunks. In some instances, a server has a number of modules used to customize and select chunks of data using a variety of factors such as user preferences, network bandwidth, subscription levels, etc. The chunks are distributed in and across a variety of network architectures such as client server, mesh, point-to-point, peer-to-peer, etc.

### CROSS REFERENCE To PRIORITY APPLICATIONS

The present application claims priority to U.S. Provisional Patent Application No. 60/788,181, filed Mar. 31, 2006 entitled “System and Method for Incremental Delivery of Instructions” by Jeremy S. de Bonet [MOBI1540]; U.S. Provisional Patent Application No. 60/788,180, filed Mar. 31, 2006 entitled “System and Method for Server-Controlled Mobile Shopping Interface” by Jeremy S. de Bonet [MOBI1550]; U.S. Provisional Patent Application No. 60/788,179, filed Mar. 31, 2006 entitled “System and Method for Augmenting Pre-Delivery Content with Personalized/Targeted Information” by Jeremy S. de Bonet [MOBI1560]; and U.S. Provisional Patent Application No. 60/791,326, filed Apr. 12, 2006 entitled “System and Method for Mobile Proxy Interfacing Console Games” by Jeremy S. de Bonet [MOBI1630], the entireties of which are incorporated by reference for all purposes.

### TECHNICAL FIELD

The present disclosure relates to network distribution of customized content and data.

### DESCRIPTION OF RELATED ART

A variety of networks allow delivery of content to end-users. In many instances, content is encoded without the benefit of customization, as customizing content for each end user is resource intensive. Conventional customization allows only limited modification of data in media files. Distributing customized data can likewise be resource intensive, as different large files have to be cached and transmitted to different entities.

Mechanisms for customizing and distributing content in network environments are limited. Consequently, it is desirable to provide improved methods and apparatus for customizing and distributing data in a variety of different networks.

### BRIEF DESCRIPTION OF THE DRAWINGS

The disclosure may best be understood by reference to the following description taken in conjunction with the accompanying drawings, which illustrate particular embodiments.

FIG. 1 illustrates one example of a system that can use the techniques of the present invention.

FIG. 2 illustrates one example of content customization.

FIG. 3 illustrates one example of a network environment.

FIG. 4 illustrates one example of a content delivery system.

FIG. 5 illustrates one example of a transcoder.

FIG. 6 illustrates one example of an augmentation mechanism.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of content streams and networks. However, it should be noted that the techniques of the present invention apply to a variety of content streams and a variety of different networks. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

Various techniques and mechanisms allow customization of data for delivery to different end users. The data can be provided as a series of chunks. In some instances, a server has a number of modules used to customize and select chunks of data using a variety of factors such as user preferences, network bandwidth, subscription levels, etc. The chunks are distributed in and across a variety of network architectures such as client server, mesh, point-to-point, peer-to-peer, etc.

### Example Embodiments

According to particular embodiments, a content delivery system modifies content, including data and multimedia content, in an efficient manner for network distribution. Particular embodiments transcode content into multiple chunks and modify the transcoded content with customized information including personalized and targeted information. In particular examples, pre-delivery content is augmented using customized information. In other examples, data is altered or removed. A wide variety of transcoders are available.

According to embodiments of the invention, transcoded content is modified based on characteristics associated with a particular user, group, region, network, etc. In particular embodiments, a system or server is configured with multiple modules, each module performing a different operation such as (e.g., select, assemble, add, and/or rearrange, etc.) under different conditions for content delivery (real time or on-demand). Conditions can be based upon many factors such as user identity, user group, user location, service plan, device, network, connection speed, user account time, time of day, etc. In this way, any input including input characteristics to the system can be factored into consideration and set up as conditions. Based on conditions, and factors associated with a particular user, personalized and/or targeted information can be added and/or used to modify the content to be delivered to that user. Thus, the pre-delivery content can be modified with customization information based on conditions and factors relevant to individual users before being distributed over a network to individual users.

Different techniques, including prepending, appending, reordering, inserting, deleting, etc., can be employed to achieve the arrangement, augmentation, and assembly of transcoded chunks on a per-user or per-group basis. In particular embodiments, the pre-delivery content can be modified by reordering transcoded chunks according to conditions and factors related to individual users. In other embodiments, the pre-delivery content from one source can be modified by inserting an additional transcoded chunk or chunks from one or more other sources.

The arrangement, augmentation, and assembly can be affected by bandwidth, usage, subscription levels, privileges, priority, etc, and many other factors on a per-user or per-group basis. Further, as will be discussed in details later, embodiments of the invention enable mobile devices to receive messages and streaming multimedia, among others, in one single stream of transcoded content. According to particular embodiments, the various chunks are distributed to a variety of network entities and a user can obtain various chunks from different entities to create a media stream. For example, various chunks can be distributed and maintained at a variety of peer nodes in a peer-to-peer network. When a user requests a particular media stream, peer nodes can be accessed first to obtain one or more chunks of data. If no chunks are available, a content server is accessed to obtain the relevant information. The chunks may be customized to suit particular network constraints such as bandwidth constraints.

Various features and details are explained more fully with reference to particular embodiments that are illustrated in the accompanying drawings and detailed in the following description. Content includes all types of data including data originating from various media sources. Examples include streaming media, live feed, broadcasts (e.g., TV broadcasts, radio broadcasts, Internet broadcasts, cellular network broadcasts, etc.), emails, images {e.g., graphics, photos, etc.), audio, video, text, etc. Pre-delivery content refers to content to be delivered to end users.

Embodiments of the present invention can be particularly useful in delivering content to end users via their mobile devices. It should be noted that these mobile devices do not need to be actually “mobile” or “portable”, but may simply be capable of wireless communications. Exemplary mobile devices include, but not limited to, cellular telephones, laptop computers, personal information managers (PIMs), personal digital assistants (PDAs), handheld computer devices, portable personal computers, etc. The content can also be delivered over a variety of different networks including Real-Time Transport Protocol (RTP), Internet Protocol (IP), peer-to-peer, and mesh networks. In particular embodiments, delivering chunks of content and customized chunks of content is particularly suited for IP and peer-to-peer networks.

Although examples of embodiments disclosed herein illustrate delivering streaming content to a cellular phone, one skilled in the art will appreciate that these examples of embodiments, or any subset thereof, can be implemented in software systems, computer programs, hardware, and any combination thereof to deliver various kinds of contents. Descriptions of well known starting materials, computer languages, processing techniques, components and equipment may be omitted so as not to unnecessarily obscure the disclosure.

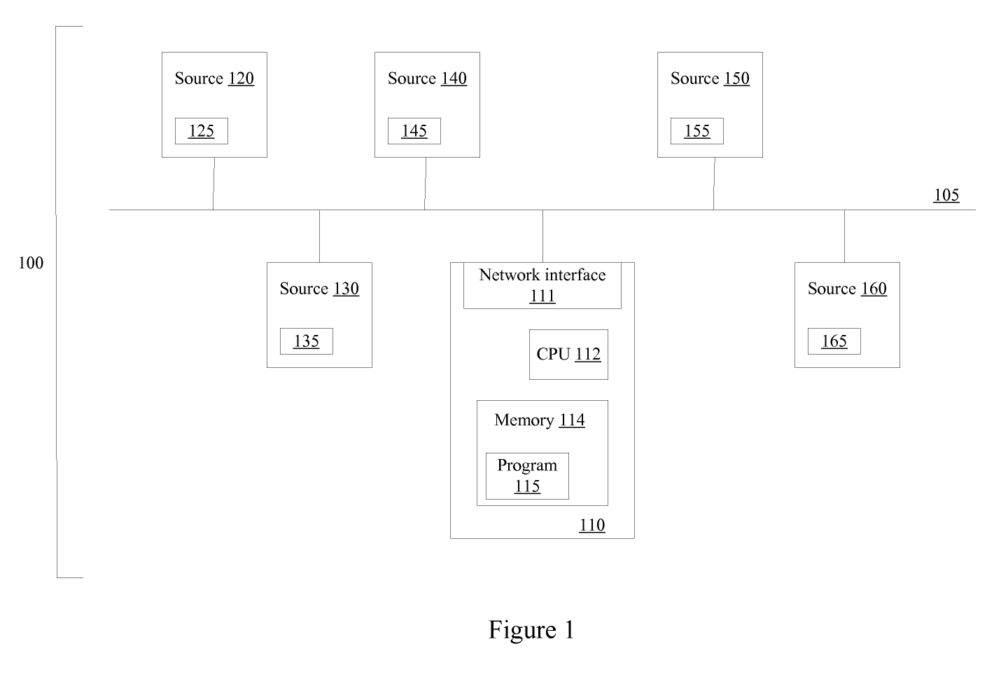

FIG. 1 illustrates an example of a system 100 according to particular embodiments. According to particular embodiments, system 100 includes a computer 110, multiple sources including source 120, source 130, source 140, source 150, and source 160, and a network communications link 105 connecting apparatus 110, source 120, source 130, source 140, source 150, and source 160. A source can include any system that is accessible by computer 110 that can provide computer 110 with desired information, e.g., configuration parameters, user data, etc. Network communications link 105 may encompass local area networks (LANs), wide area network (WANs), Internet, wireless networks, and any other communications networks known in the art. Computer 110 can include a network communications device such as an Ethernet card, a modem, or other communication device known in the art for interfacing computer 110 with network communications link 105.

Computer 110 can further include a central processing unit (CPU) 112 and a computer readable memory 114 (e.g., random access memory (RAM), read only memory (ROM), magnetic storage, optical storage device and/or any other computer readable memory known in the art) storing a program 115 that is executable by CPU 112. Program 115 can be a portion (e.g., a module) of a large program, such as a content delivery application, and may be implemented in any suitable programming structure (e.g., plug-in, function, stand alone program) or language known to those of ordinary skill in the art.

Each of the plurality of sources 120, 130, 140, 150, 160 can similarly include a network communications device and/or network interface and an input interface. Computer readable media can store a configuration source program 125, a configuration source program 135, a configuration source program 145, a configuration source program 155, and a configuration source program 165. Each configuration source program can be a portion of a large program, such as a content delivery application, and may be implemented in any suitable programming structure or language known in the art.

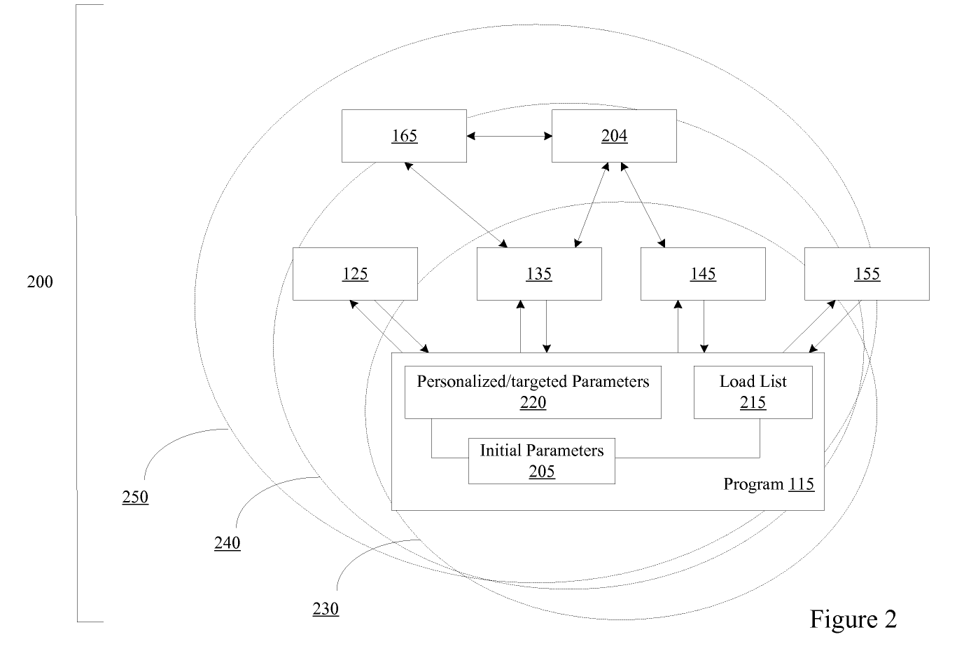

FIG. 2 shows one example of how user-specific configuration parameters (e.g., name-value pairs) can be established for program 115 through a multi-transaction conversation that dissociates program 115 from sources 120-160 storing those parameters. According to particular embodiments, the conversation is directed, at least in part, by external logic at sources 120-160 and can include a series of requests for configuration parameters and replies containing those parameters. The conversation can take place using HyperText Transfer Protocol (HTTP) or any number of communications protocols known or developed in the art, for example, raw TCP/IP, FTP, UDP, HTTPS, Gopher, news, POP, SMTP, SNMP, etc.

According to particular embodiments, program 115 initiates a conversation at the occurrence of any predefined event (e.g., startup, user login, change of channel, receipt of a request from another computer, etc.) In one embodiment, to initiate the conversation, program 115 loads a set of initial configuration parameters 205. As shown in FIG. 2, the initial parameters can specify an initial load list 215 including a list of configuration sources that are to be queried for additional configuration information, which can include factors and associated conditions. Initial parameters 205 and load list 215 can be stored in a database, a file, or any other form known in the art. According to particular embodiments, program 115 can make multiple requests to one or more sources 120-160 via communications link 105. In particular embodiments, program 115 can make an initial request for configuration information to an initial source 120 having a source program 125 capable of processing the initial request. The initial request can be a simple request, for example, an HTTP request and can include request parameters associated with apparatus 110. As an example, if apparatus 110 is associated with a particular username, the initial configuration parameters can specify that the initial request include a request parameter “user=username” (i.e., a specified condition). If the request is made as an HTTPrequest, the username can be included as part of a common gateway interface (CGI) request, for example, www.entity.com/configsource120/User?user=username. Requests formed according to other protocols and interfaces are also possible.

Based on the particular user name in the initial request, source program 125 can determine additional factors and associated conditions. For example, the source program 125 can determine that the particular user has a PDA and is in a specific premium movie channels subscribers group. According to particular embodiments, a source program 125 can then format a response including a set of configuration parameters associated with each user that accesses source program 125 (i.e., global settings), a set of configuration settings associated with the username (e.g., preferred settings, etc.), and/or information related to additional request(s) that program 115 can make to other sources.

The additional request information can specify, for instance, that program 115 query source 130 for parameters, factors, and conditions, etc. related to a specific user device (e.g., a PDA) and query source 140 for parameters relating to a particular user group {e.g., a premium movie channels subscribers group). Upon receipt of the initial response from source program 125, program 115 can store any received parameters as part of a set of personalized parameters 220 and add the additional requests to load list 215. Based on the initial response from source program 125, program 115 can then query source 130 by making a request to source program 135. Like source program 125, upon receiving the request from program 115, source program 135 can generate a response containing the requested information and/or additional request information, which program 115 can add to the set of personalized parameters 220 and load list 215, respectively.

Similarly, based on the request from program 115, source program 145 residing at source 140 can generate a response containing the requested information and/or additional request information, which may specify that program 115 query source 150 (i.e., send a request to source program 155).

According to particular embodiments, program 115 uses an Internet Protocol (IP) address and login information to begin a series of processes as described above (i.e., a multi-transaction conversation) and obtain data about that user and/or the user's mobile device from one or more sources. Additionally, one source can query another one or more sources in preparing and generating a reply to a request. If, for example, source program 165 is part of a network system that monitors bandwidth usage, and configuration parameters associated with user's premium movie channels subscribers group are dependent on the available bandwidth, source program 135 can query source program 165 prior to responding and can further query other resources, such as source program 204, prior to responding to source program 135. This transaction sequence can quickly provide relevant user data over a variety of network architectures.

More specifically, transaction sequence or conversation 230 can include exchanging information between program 115 at computer 110 and source programs 135, 145, and 155 at sources 130, 140, and 150, respectively. As the conversation continues, conversation 230 expands into conversation 240 to include exchanging information between source programs that can directly communicate with program 115 (e.g., source programs 135 and 145) and source programs that do not (e.g., source programs 165 and 204). Conversation 240 can expand further into conversation 250, which can include exchanging information between source programs that have no direct connection with program 115 (e.g., source programs 165 and 204).

Each response to program 115 can optionally include a set of special parameters that contain cache directives applicable to parameters that are included in one response or received in one entire conversation or exchange. By way of example, a response from one source can contain directives such as timeout periods. In particular examples, “Valid Since First Used 1000 Seconds” and “Valid Since Last Used 500 seconds” are possible directives that indicate that a particular response will only be cached for 1000 seconds from their first use or 500 seconds from their last use by program 115. In this manner, one source can dictate the lifespan of certain parameters (i.e., how long they should be cached).

According to particular embodiments, the response generated by each source program can be based on the request received from program 115. The response from a particular source program, including parameters and additional request information, can be the result of an attribute of the request, such as the originating IP address of the request or parameters stored in the request (e.g., user name, time, CPU load or other parameters as would be understood by those of ordinary skill in the art) or can be the result of internal logic such as determining the time at a source.

In one embodiment, load list 215 defines the requests to be made by program 115. For example, load list 215 can contain the following requests: yoursource.com/UserInfor?user=UserID, yoursource.com/ClassInfo?class=CLASS, yoursource.com/DeviceInfo?device=DEVICE.

In this case, program 115 can determine the User ID and Device from, for example, initial parameters 205, which can be stored in a file or database. Program 115 can also determine the “class” parameter from initial parameters 205. Alternatively, the value for the “class” parameter can be defined in a response from one of the sources, e.g., a “UserInfo” Common Gateway Interface (CGI). In this example, each CGI hosted at yoursource.com can represent a different configuration source.

One of ordinary skill in the art will appreciate that, in addition to the example described above, there are many possible ways to gather and aggregate user-specific information from various sources. Various embodiments are not limited by any particular way in which user-specific information is obtained or how user-specific configuration parameters are established.

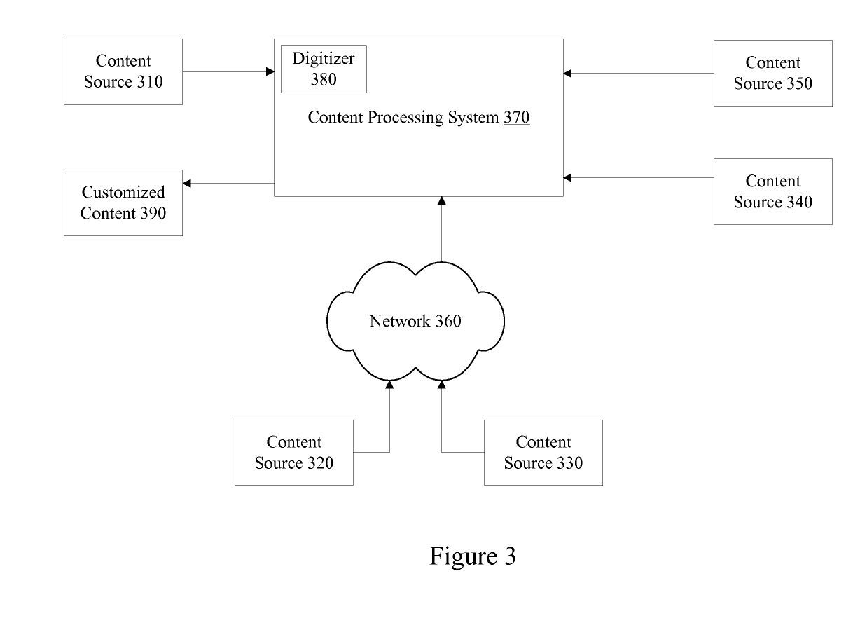

FIG. 3 shows an example of a network environment 300 in which particular embodiments may be implemented. According to particular embodiments, network environment 300 includes a content processing system 370 which is communicatively coupled to multiple content sources, e.g., source 310, source 320, source 330, source 340, and source 350. These content sources 310-350, which may be implemented as stand-alone devices or included at server(s), can be the same as, similar to, or different from the configuration sources 120-160 described above. Similar to network communications link 105 described above, the network communications links in network environment 300 are not limited by any wired or wireless medium.

According to particular embodiments of the invention, content processing system 370 is implemented at a Content Delivery Server to which content sources 310-350 are directly and/or indirectly (e.g., via the Internet 360) connected. Content Delivery Server embodying content processing system 370 can have software and hardware components similar to computer 110. Software components include computer executable program instructions stored on a computer readable medium such as a floppy disk, a compact disc read-only memory (CD ROM), or any suitable data storage device.

In one embodiment, Content Delivery Server embodying content processing system 370 is configured with computer executable program instructions to receive content from content sources 310-350, digitize the incoming content if necessary, transcode the digitized content into self-sufficient chunks in various formats, modify the transcoded chunks, and deliver the resulting stream of transcoded chunks with personalized/targeted information {e.g., 390) to a plurality of individual users over a variety of different network architectures. Content sources 310-350 may provide digital content as well as analog content. In the latter case, content processing system 370 can include a digitizer 380 for converting incoming analog data into a digital form that is suitable for transcoding.

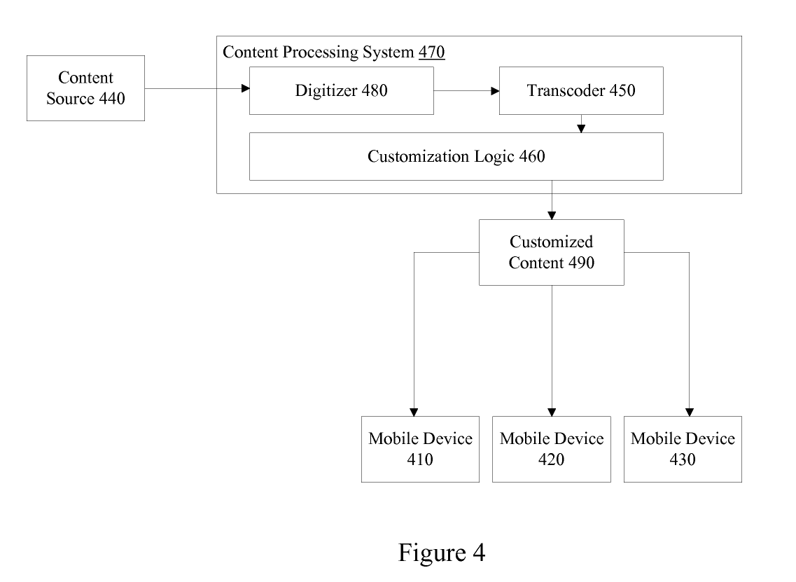

FIG. 4 illustrates one example of a content delivery system 400. According to particular embodiments, content delivery system 400 includes a content processing center 470 residing at a server for receiving content 440 from content sources such as content sources 310-350, digitizing content 440, if necessary, via digitizer 480, transcoding digitized content into self-sufficient chunks, if necessary, via transcoder 450, modifying transcoded chunks with personalized/targeted information to generate a stream of data 490, and delivering each modified, personalized data stream 490 to individual users via their mobile devices, e.g., 410, 420, and 430. According to particular embodiments, modified content 490 can be communicated to mobile devices 410, 420, and 430 through wired media, wireless media, base stations, satellite vehicles, or a combination thereof, depending upon the network environment in which content delivery system 400 is embodied.

In particular examples, content processing center 470 includes a transcoder component 450, a customization component 460, and a digitizer component 480. In some embodiments, either or both transcoder 450 and digitizer 480 can be optional. A customization component 460 may be a modification or augmentation component. As described above, if incoming content 440 is not already in a digital format, digitizer 480 may capture and convert incoming analog content, e.g., television signals or radio broadcasts, into a variety of formats. One of ordinary skill in the art will appreciate that digitizer 480 can be realized in many ways. For example, raw TV signal may be captured and converted into a digital format by a TV tuner card having a standard analog to digital converter (ADC) known in the art. Similarly, transcoder 450 may not be necessary if incoming content is already in a form of a series of transcoded chunks.

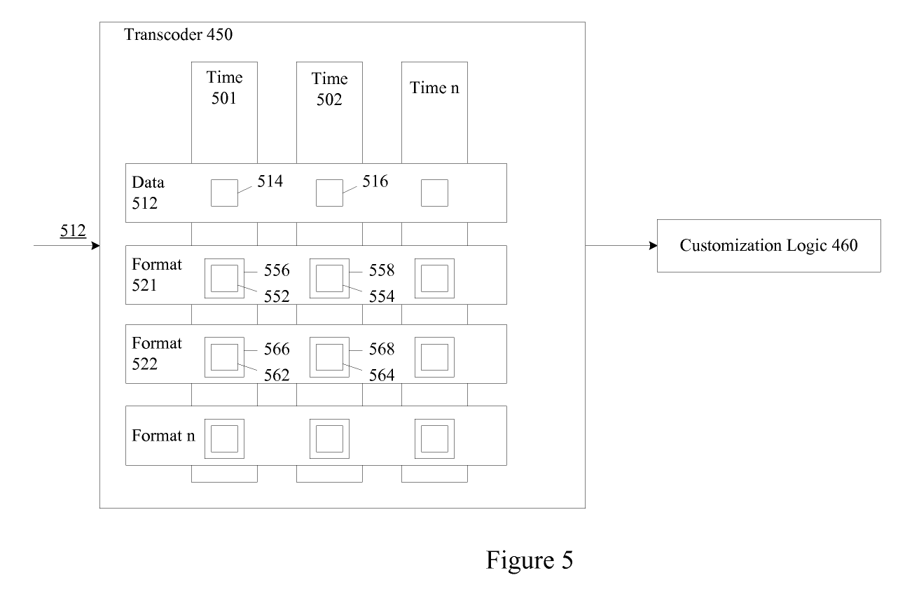

FIG. 5 illustrates one embodiment of transcoder 450 shown in FIG. 4. In this example, incoming content 512, which is in a digital format, is divided into a plurality of portions 514, 516, etc. and converted into a variety of different formats 521, 522, etc. The resulting portions 552, 554, 562, 564, etc. of data in different formats 521, 522, etc. cover time periods 501, 502, etc. corresponding to portions 514, 516, etc. of original content 512. More specifically, suppose that incoming content 512 is digitized video data divided into portions 514, 516, etc., portion 514 may cover the first 10 seconds (time period 501) and portion 516 may cover the next 10 seconds (time period 502) of the video represented by original content 512, and so on. Portions 514, 516, etc. may then be converted to different formats 521, 522, etc. The resulting data portions 552, 562 corresponding to original portion 514 represent the same first 10 seconds in time period 501 albeit in different formats 521, 522, etc. Similarly, portions 554, 564 corresponding to original data portion 516 represent the second 10 sections in time period 502 of original content 512 in different formats 521, 522, etc.

During this conversion process, each portion 552, 554, 562, 564 and so on may be modified (e.g. reduced, enlarged, expanded, enhanced, or supplemented with additional information). It should be noted that, since transcoding can be performed independently by a third party, e.g., a content source may supply streaming data in transcoded chunks, this additional information may or may not pertain to the needs and desires of individual users. For example, general information regarding closed captioning may be added to portion 552 in format 521 or a Java applet may be added to portion 564 in format 522. Through the use of compression algorithms and the like, portions 552, 554, 562, 564, etc. can also be optimized for delivery.

According to particular embodiments, portions 552, 554, 562, 564, etc. are then encapsulated into chunks 556, 558, 566, 568, etc., also referred to as transcoded chunks. The encapsulation can include condensing or expressing each chunk into a concise form (see below for an example of a chunk expressed in Bakus-Naur Form (BNF)) and/or enclosing the chunk with commands and/or headers to prepare it for delivery, for example, to the mobile devices 410-430 shown in FIG. 4. The mobile devices 410-430 are configured to process, control, and render the command and data contained within transcoded chunks 556, 558, 566, 568, etc. In particular examples, each transcoded chunk can be seen as a block of data that can be independently analyzed, e.g., by a processor at a server or a mobile device, and rendered according to information contained therein, which makes each transcoded chunk uniquely self-sufficient. The various transcoded chunks can be obtained from a single server, multiple server, multiple computer systems, multiple peer nodes, or a combination thereof. Although a wide variety of formats are possible, in particular embodiments, one format of a transcoded chunk can be represented in the Bakus-Naur Form (BNF) as follows:

| | |
|---|---|
| encapsulation | <command>* |
| command | <tag><length><payload> |

tag :_ <byte>
length [1-9) {12}](an integer in % 12d format) payload := <bytes> {<length>}

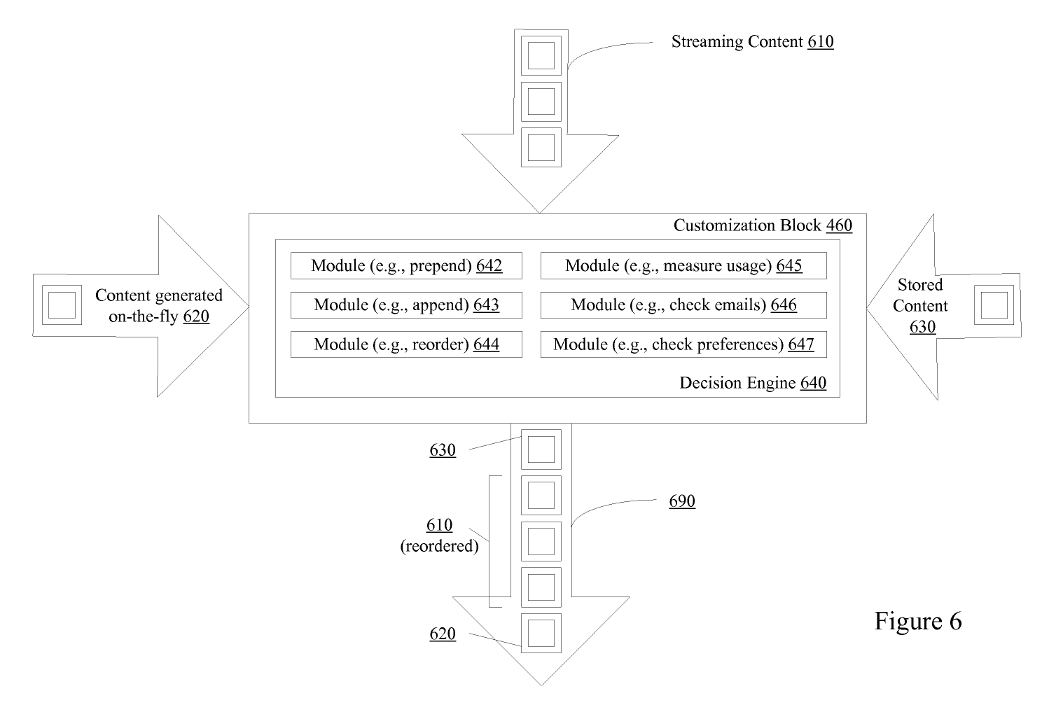

FIG. 6 illustrates one embodiment of the augmenter component 460 shown in FIG. 4. According to particular embodiments, transcoder 450 and customization logic 460 can be distributed and need not reside at the same location. Customization logic 460 can be a separate program or piece of code that operates to modify transcoded chunks provided by using customization information including any parameters, user preferences, group preferences, etc.

In particular examples, these and other functionalities of customization logic 460 are realized using modules 642, 643, 644, 645, 646, and 647 residing in a decision engine 640. These modules 642-647 can be initialized or otherwise configured with personalized configuration parameters when customization logic 460 first runs. According to particular embodiments, these personalized configuration parameters are provided by program 115 described above. In one embodiment, both customization logic 460 and program 115 can be part of one content delivery system. In other embodiments, customization logic 460 can import personalized parameters from other sources and configure its modules accordingly.

In one embodiment, each module is configured to perform a particular function, e.g., module 642 may be configured to prepend or otherwise add one or more transcoded chunks to a series or stream of transcoded chunks, module 643 may be configured to append one or more transcoded chunks to a series of transcoded chunks, module 644 may be configured to reorder one or more chunks in a stream or series of transcoded chunks, module 645 may be configured to measure network bandwidth, memory usage, time, etc., module 646 may be configured to communicate with email server(s), and module 647 may be configured to assert certain user preference(s), and so on.

These modules may work independently and/or cooperatively to arrange, augment, and assemble chunks of transcoded data differently for different individual users based on personalized parameters, factors, and conditions (e.g., obtained by program 115 as described above) and/or user preference(s). By way of. example, users A and B both subscribed to receive streaming content 610, in this case, a TV program that includes news (N), sports (S), and weather (W) segments. User A may want to receive news first, sports next, and then weather, while user B may want to receive weather first, news next, and then sports. Without having to re-transcode or re-code the entire streaming content for individual users, module 644 can operate to reorder the transcoded chunks of streaming content 610, i.e., chunks or chunk streams for user A would be arranged and assembled in a different order (e.g., N-S-W) than for user B (e.g., W-N-S).

In one embodiment, the arrangement and assembly can be performed in various ways depending upon network bandwidth, quality of content (e.g., image resolution), user preference, etc. In one embodiment, chunks and/or streams of chunks can be dynamically assembled on-the-fly on a per-user basis to particularly alleviate some of the bandwidth problems related to network communications channels. For example, during transmission of a live broadcast, user A's mobile device dropped out of a high bandwidth communications channel. Since these chunks can be time-synchronized and ordered from high bandwidth to low bandwidth, a low bandwidth chunk can quickly replace its corresponding high bandwidth chunk's place in the data stream being assembled on-the-fly. That is, the live broadcast is not dropped, although the image quality might be lower for the time being. This allows the augmentation of user A's TV program to dynamically adapt to available optimal bandwidth without having to interrupt the delivery of the TV program.

In one embodiment, module 645 is configured to measure network traffic on a carrier by carrier basis. For example, carrier C may have a limit of, e.g., 2 MB, for a basic service plan. Module 645 can operate to send a warning message to individual user(s) whose usage is approaching or exceeding the limit. Such a warning message as well as other content generated on-the-fly (e.g., 620) can be dynamically transcoded and prepended or appended to the series of transcoded chunks that is being transmitted (delivered) to the individual user(s). Module 645 can be linked to an update module that sends an invitation, along with the warning message, to update to a service plan that offers a higher limit, e.g., 5 MB, on usage. Such an invitation would also be first transcoded and then prepended or appended to the series of transcoded chunks along with the warning message. Stored content (e.g., 630) can be delivered to end users in a similar fashion. Examples of stored content includes commercial ads, public service announcements, etc., all of which can be stored as transcoded chunks in a database or repository that is readily accessible by customization logic 460.

According to particular embodiments, the underlying content delivery system (e.g., system 400) keeps track of channels that each individual user is receiving by scanning past and present channels of each user to see whether a change of channel has occurred. If so, module 642 may operate to prepend a commercial ad (in transcoded chunks) to the next stream of data. Similarly, module 646 may operate to generate a message (to be transcoded and prepended to the data stream to be delivered) that notifies a user of an incoming email. Additionally, if a user selects a channel to which the user has not subscribed, an upgrade module may operate to generate a preview or commercial ad for that channel, along with an invitation to subscribe. Again, transcoded chunks of the preview, commercial ad, and invitation can be generated on-the-fly and/or obtained from a suitable repository on a per-user basis as described above. These modules can run independently.

Moreover, users can have the options of not having certain chunks delivered, e.g., turn off incoming mail warning or block pornographic images. In this case, user B has elected not to receive any pornographic content. Without having to re-transcode or re-encode the entire streaming content for user B, module 647 simply checks a particular parameter that specifies this user preference and causes an appropriate module (e.g., module. 644) to change the order of the transcoded chunks of streaming content 610 so that chunks that have been flagged as containing pornographic images will not be delivered to user B. This is useful in cases where it is not possible to have a separate module to specifically block pornographic images.

According to one embodiment of the invention, modules 642-647 are configured to perform different types of operations under different conditions. Conditions can be based upon many factors such as user preferences, user device, network, user location of the user, user account type, time of day, any input to the underlying system (e.g., system 400) and input characteristics associated therewith can be factored into consideration and specified as conditions. Therefore, modules 642-647 are not meant to be limiting and there could be other possible modules that can use these factors to make decisions about what to deliver and to whom. Since conditions change, the content that is being delivered to individual users is continuously customizable.

It should be noted that embodiments of the invention can modify transcoded content with additional data from multiple sources {i.e., content providers as well as within the content delivery system). Embodiments of the invention can take a stream of transcoded multimedia (audio, video, image, and/or text) content from one source, reorder the chunks if necessary, and insert or add to the stream additional multimedia (audio, video, image, and/or text) content from other sources according to the needs and desires of individual users. As exemplified in FIG. 6, in order to generate transcoded content 690 modified with personalized and/or targeted information for delivery to individual users, streaming content 610 is reordered, prepended with on-the-fly content 620 and appended with stored content 630. All three types of content (i.e., streaming content 610, on-the-fly content 620, and stored content 630) can be considered pre-delivery content. According to embodiments of the invention, to deliver 610, 620, and 630 together as one data stream, 610, 620, and 630 contain transcoded chunks having the same or compatible format.

Each chunk of modified content 390 delivered to a mobile device can then be decoded and executed by extracting commands encapsulated therein. In the foregoing specification, the invention has been described with reference to specific embodiments. However, one skilled in the art will appreciate that the methods and systems described herein can be implemented in various ways. For example, in addition to pre-delivery content that had been preceded into transcoded chunks, it may be possible to modify pre-delivery media streams in various formats, e.g., Moving Picture Experts Group (MPEG), MPEG Audio Layer-3 (MP3), Audio Video Interleaved (AVI), Windows Media Video (WAV), etc. So long as the personalized/targeted information is in the same or compatible format as the incoming data stream, customization logic 460 described above can be adapted to accommodate different data formats.

By way of example, suppose a user is watching a movie which is being streamed to the user's cellular phone. Unbeknownst to the user, a new email message awaits at the user's email server. In this case, customization logic 460 can operate to communicate with the email server and obtain the new email message to modify the pre-delivery portion of content (i.e., the portion of the movie yet to be delivered) with personalized information (i.e., the email). More specifically, customization logic 460 can 1) generate and deliver a notice about the incoming email message to the user or 2) deliver the actual email message to the user. In this embodiment, either the notice or the actual email message is converted into images (or frames of images in the same or compatible format as the movie) and then inserted into the data stream as part of the movie. The insertion can be done by scanning boundaries or breaks in the media stream. In other words, if a new email comes in as the user watches the movie, a notice or actual email message can be played or displayed as part of the movie on the cellular phone. Since the augmentation is performed prior to delivering the media content to the user, personalization can be achieved in the same data stream without having to re-code the entire media content and without requiring additional network bandwidth.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
receiving media stream at a network device, wherein the media stream is transcoded into a plurality of chunks, each of the plurality of chunks including a portion of the media stream;
modifying one of the plurality of chunks using customization information to generate a customized chunk;
sending the plurality of chunks and the customized chunk to a plurality of network nodes, wherein a user obtains the customized chunk and ones of plurality of chunks to receive the media stream.

2. The method of claim 1, wherein customization information is associated with the user.

3. The method of claim 1, wherein customization information is associated with user preferences.

4. The method of claim 1, wherein customization information is associated with group preferences.

5. The method of claim 1, wherein customization information is associated with network constraints.

6. The method of claim 1, wherein modifying one of the plurality of chunks comprises augmenting one of the plurality of chunks with additional content.

7. The method of claim 1, wherein modifying one of the plurality of chunks comprises removing content to meet network constraints.

8. The method of claim 1, wherein modifying one of the plurality of chunks comprises generating a plurality of customized chunks.

9. The method of claim 1, wherein each of the plurality of chunks is reduced in size to meet network constraints.

10. The method of claim 1, wherein each of the plurality of chunks is associated with timing information.

11. The method of claim 1, wherein the plurality of chunks are sent to a plurality of network nodes connected in a peer-to-peer network.

12. The method of claim 1, wherein the customized chunk includes advertising information targeted to the particular user.

13. The method of claim 1, wherein the user is associated with a mobile device.

14. A system, comprising:
an interface operable to receive a media stream, wherein the media stream is transcoded into a plurality of chunks;
a processor operable to modify one of the plurality of chunks using customization information to generate a customized chunk;
wherein the interface is further operable to send the plurality of chunks and the customized chunk to a plurality of network nodes, wherein a user obtains the customized chunk and ones of plurality of chunks to receive the media stream.

15. The system of claim 14, wherein customization information is associated with the user.

16. The system of claim 14, wherein customization information is associated with user preferences.

17. The system of claim 14, wherein customization information is associated with group preferences.

18. The system of claim 14, wherein customization information is associated with network constraints.

19. The system of claim 14, wherein modifying one of the plurality of chunks comprises augmenting one of the plurality of chunks with additional content.

20. The system of claim 14, wherein modifying one of the plurality of chunks comprises removing content to meet network constraints.

21. The system of claim 14, wherein modifying one of the plurality of chunks comprises generating a plurality of customized chunks.

22. The system of claim 14, wherein each of the plurality of chunks is reduced in size to meet network constraints.

23. The system of claim 14, wherein each of the plurality of chunks is associated with timing information.

24. The system of claim 14, wherein the plurality of chunks are sent to a plurality of network nodes connected in a peer-to-peer network.

25. The system of claim 14, wherein the customized chunk includes advertising information targeted to the particular user.

26. The system of claim 14, wherein the user is associated with a mobile device.

27. A system, comprising:
means for receiving media stream, wherein the media stream is transcoded into a plurality of chunks, each of the plurality of chunks including a portion of the media stream;
means for modifying one of the plurality of chunks using customization information to generate a customized chunk;
means for sending the plurality of chunks and the customized chunk to a plurality of network nodes, wherein a user obtains the customized chunk and ones of plurality of chunks to receive the media stream.

28. A computer readable storage medium having computer code embodied therein, the computer readable storage medium comprising:
computer code for receiving media stream;
computer code for transcoding the media stream into a plurality of chunks, each of the plurality of chunks including a portion of the media stream;
computer code for modifying one of the plurality of chunks using customization information to generate a customized chunk;
computer code for sending the plurality of chunks and the customized chunk to a plurality of network nodes, wherein a user obtains the customized chunk and ones of plurality of chunks to receive the media stream.
